(19) United States
(12) Patent Application Publication
(10) Pub. No.: US 2026/0085849 A1
(43) Pub. Date: Mar. 26, 2026

(54) TEMPERATURE CONTROL METHOD, ELECTRONIC DEVICE, AND STORAGE MEDIUM

(71) Applicant: HON HAI PRECISION INDUSTRY CO., LTD., New Taipei (TW)

(72) Inventors: Jung-Hao Yang, New Taipei (TW); Chih-Te Lu, New Taipei (TW); Chin-Pin Kuo, New Taipei (TW)

(21) Appl. No.: 19/049,117

(22) Filed: Feb. 10, 2025

(30) Foreign Application Priority Data
Sep. 26, 2024 (CN) 202411353654.2

(51) Int. Cl. F24F 11/63; G05B 13/04

(52) U.S. Cl. CPC F24F 11/63; G05B 13/048

(57) ABSTRACT

The present application provides a temperature control method, an electronic device, and a storage medium. The temperature control method includes obtaining real-time environmental data of a plurality of areas in a building, and obtaining target temperatures of temperature control devices in different areas. The real-time environmental data includes temperature data and personnel activity data. Once a temperature change trend of each area and temperature difference information between different areas are determined based on real-time environmental data, a preset strategy prediction model is used to dynamically adjust operating parameters of the temperature control devices based on the temperature change trend, the temperature difference information and the target temperatures.

### TECHNICAL FIELD

The present application relates to a field of intelligent control technology, and specifically to a temperature control method, an electronic device, and a storage medium.

### BACKGROUND

With an acceleration of urbanization and a continuous development of construction technology, modern buildings are facing increasingly severe challenges in temperature management. Specifically, due to a large size, a complex structure and diverse usage requirements of modern buildings, a temperature control has become an extremely challenging task. Especially in large commercial complexes, office buildings, high-rise residential buildings and other buildings, an indoor temperature distribution is extremely uneven due to an influence of factors such as a sunlight intensity, a wind direction and a wind speed, and a crowd density in different areas.

Traditional temperature control methods often rely on fixed preset rules and simple logical control, which lack a comprehensive consideration of complex environmental factors and dynamic response capabilities, and are unable to cope with the above-mentioned problem of uneven indoor temperature distribution, resulting in inefficient temperature management and serious energy waste, which not only affects a comfort of a building's internal environment, but may also have an adverse effect on a building structure and an equipment life.

### BRIEF DESCRIPTION OF DRAWINGS

FIG. 1 is a schematic diagram of a flow chart of a temperature control method provided in one embodiment of the present application.

FIG. 2 is a schematic diagram of a hardware structure of an electronic device provided in an embodiment of the present application.

FIG. 3 is a schematic diagram of a flow chart of a temperature control method provided in yet another embodiment of the present application.

FIG. 4 is a schematic diagram of functional modules of a temperature control apparatus provided in one embodiment of the present application.

### DETAILED DESCRIPTION

The embodiments of the present application are described in detail below, and examples of the embodiments are shown in the accompanying drawings, where same or similar reference numerals throughout represent same or similar elements or elements having same or similar functions. The embodiments described below with reference to the accompanying drawings are exemplary and are only used to explain the present application, and cannot be understood as limiting the present application.

In the embodiments of the present application, it should be noted that, unless otherwise clearly specified and limited, words such as “for example” are used to indicate examples, illustrations or explanations. Any embodiment or design described as “for example” in the embodiments of the present application should not be interpreted as being more preferred or more advantageous than other embodiments or designs. Specifically, the use of words such as “for example” is intended to present related concepts in a specific way.

In the description of this application, it should be noted that, unless otherwise clearly specified and limited, the terms “installed”, “connected”, and “connected” should be understood in a broad sense, for example, it can be a fixed connection, a detachable connection, or an integral connection; it can be a mechanical connection, an electrical connection, or mutual communication; it can be a direct connection, or an indirect connection through an intermediate medium, it can be an internal connection of two elements or an interaction relationship between two elements. For a skilled in the art, specific meanings of the above terms in this application can be understood according to specific circumstances.

In the description of the present application, it should be noted that, unless otherwise expressly specified and limited, terms “first” and “second” are used for descriptive purposes only and cannot be understood as indicating or implying relative importance or implicitly indicating the number of technical features indicated. Therefore, features defined as “first” and “second” may explicitly or implicitly include one or more of the features. In addition, in the description of the present application, meaning of “a plurality” is two or more, unless otherwise clearly and specifically limited.

In order to more clearly understand the above-mentioned purpose, features and advantages of the present invention, the present invention is described in detail below in conjunction with accompanying drawings and specific embodiments. It should be noted that the embodiments of the present application and the features in the embodiments can be combined with each other without conflict.

Traditional temperature control methods often rely on fixed preset rules and simple logical control, which lack a comprehensive consideration of complex environmental factors and dynamic response capabilities, and are unable to cope with the above-mentioned problem of uneven indoor temperature distribution, resulting in inefficient temperature management and serious energy waste, which not only affects a comfort of a building's internal environment, but may also have an adverse effect on a building structure and an equipment life.

In view of the above, the present application provides a temperature control method, an electronic device and a storage medium to solve the above-mentioned technical problems.

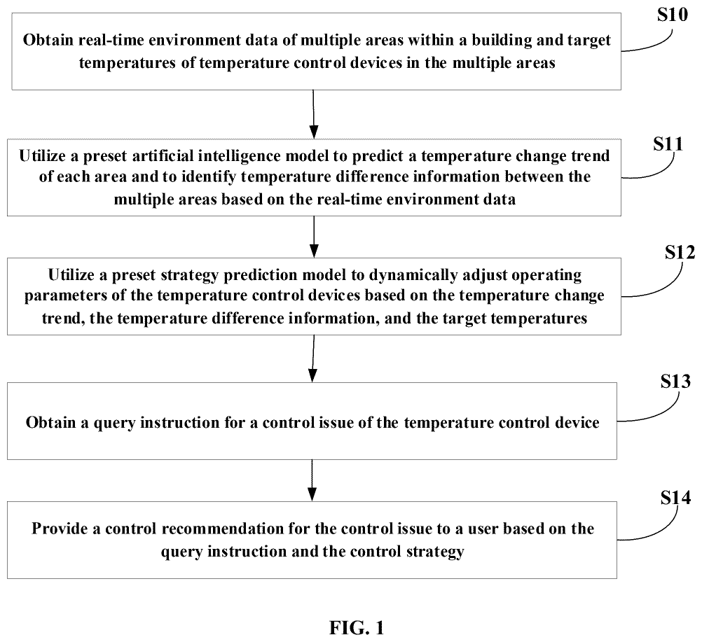

Please refer to FIG. 1, which is a schematic diagram of a flow chart of a temperature control method provided in an embodiment of the present application.

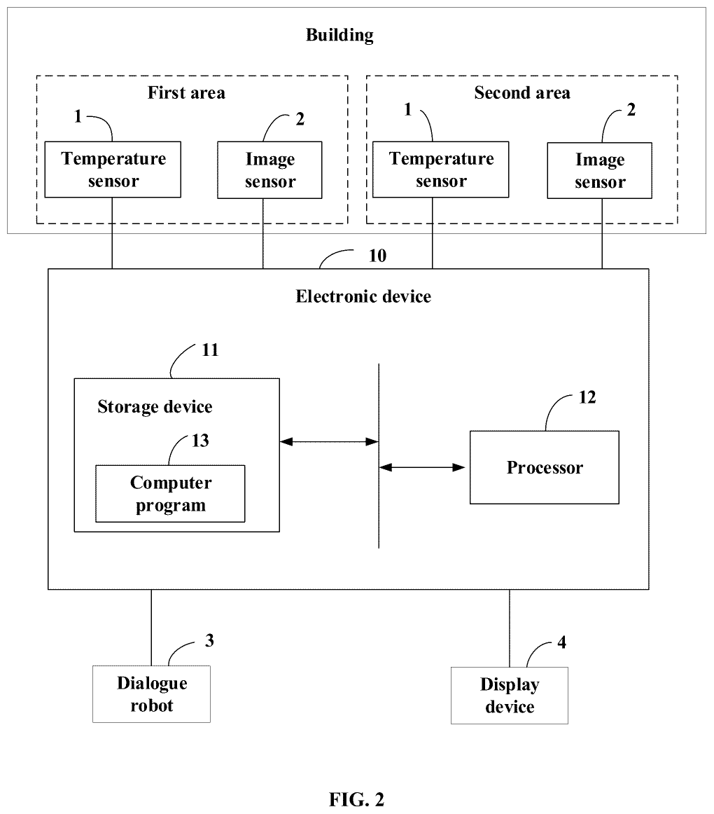

The temperature control method provided in the embodiment of the present application is applied to one or more electronic devices 10 (as shown in FIG. 2). The electronic device 10 is a device that can automatically perform numerical calculations and/or information processing according to pre-set instructions or stored instructions. Its hardware includes but is not limited to a microprocessor, an application specific integrated circuit (ASIC), a field-programmable gate array (FPGA), a digital signal processor (DSP), an embedded device, etc.

In other embodiments, the electronic device 10 can be connected to a desktop computer, a notebook, a personal digital assistant (PDA), a cloud server, etc. The electronic device 10 can interact with a user through a keyboard, a mouse, a remote control, a touch pad, or a voice control device.

Specifically, the temperature control method includes following blocks. According to different requirements, an order of some blocks in the flow chart can be changed, and some blocks can be omitted.

The present application relates to the field of intelligent control technology, and specifically to a temperature control method, device, equipment and storage medium.

In block S10, real-time environment data of multiple areas within a building and target temperatures of temperature control devices in the multiple areas are obtained.

In some embodiments of the present application, the real-time environment data includes temperature data and personnel activity data.

In some embodiments of the present application, temperature sensors 1 are installed in the multiple areas (e.g., a first area, and a second area) within the building, and are communicated with the electronic device 10. The electronic device 10 obtains the temperature data collected by the temperature sensors 1 and monitors temperatures of the multiple areas within the building in real time according to the collected temperature data. In some embodiments of the present application, target temperatures of temperature control devices in different areas may be same or different.

The method for obtaining personnel activity data may include:

In some embodiments of the present application, image sensors 2 (e.g., cameras) are installed in the multiple areas (e.g., the first area, and the second area) within the building, and are communicated with the electronic device 10. The image sensors 2 capture image data in the multiple areas within the building in real time. The electronic device 10 obtains the image data from the image sensors 2; performs preprocessing operations, such as an image denoising, a background removal, and an image enhancement on the image data; and obtains the personnel activity data by extracting features of personnel activities based on a deep learning model (e.g., a convolutional neural network, a recurrent neural network).

The electronic device 10 integrates a management system for the temperature control devices, such as a centralized air conditioning control system, such that the electronic device 10 can obtain the target temperatures set by users for the temperature control devices installed in the multiple areas from the management system that is integrated.

In the above embodiments, by installing the temperature sensors 1 and the image sensors 2 in different areas within the building, the temperature data and the personnel activity data can be monitored in real time. This provides a more comprehensive actual environmental status for a subsequent adjustment of operating parameters of the temperature control devices, allowing for a precise regulation based on actual environmental conditions. For example, a ventilation can be increased in a densely populated area, and the target temperature can be lowered in an area with a higher temperature to maintain a comfortable indoor environment.

In other embodiments, the real-time environment data may also include, but is not limited to, humidity data, energy consumption data, and sound data.

In some embodiments of the present application, the building may be a residential building, an office building, and a shopping mall. The present application does not limit on this. The multiple areas within the building may include, but are not limited to, areas located at different positions within the building.

In some embodiments of the present application, the temperature control devices are installed in different areas within the building, which may include, but are not limited to, compressors and air supply fans.

In some embodiments of the present application, after obtaining the real-time environment data of the multiple areas within the building, the electronic device 10 may store the real-time environment data in a preset local database or a preset cloud server. In the above embodiments, storing the real-time environment data in a local database can improve a speed of accessing the real-time environment data, enabling instant responses when analyzing real-time environment data in subsequent blocks. It also reduces a risk of the real-time environment data being intercepted or leaked during a transmission, helping to protect a security and a privacy of the real-time environment data within the building. In an event of an instability or an interruption if occurred in a network, the local database can still function normally, ensuring a continuity and an integrity of the real-time environment data. The cloud server typically has automatic backup and recovery functions, which can effectively prevent a loss and a damage of the real-time environment data, ensuring an integrity and an availability of the real-time environment data. The cloud server allows a building manager and maintenance personnel to access the real-time environment data from different locations via the internet, enabling a remote monitoring and management, supporting a multi-person collaboration, and improving a work efficiency and a convenience of sharing the real-time environment data.

In block S11, a preset artificial intelligence model is utilized to predict a temperature change trend of each area and to identify temperature difference information between the multiple areas based on the real-time environment data.

In some embodiments of the present application, before executing the block S11, the electronic device 10 needs to associate a location marker of each area with the real-time environment data of each area. This allows for predicting the temperature change trend of each area and identifying the temperature difference information between different areas based on the real-time environment data of each area.

Specifically, the electronic device 10 utilizes the preset artificial intelligence model to predict a temperature change trend of each area and to identify temperature difference information between the multiple areas based on the real-time environment data by: preprocessing the real-time environment data of each area to obtain preprocessed real-time environment data of each area; predicting the temperature change trend of each area and identifying the temperature difference information between the multiple areas by utilizing the artificial intelligence model based on the preprocessed real-time environment data.

In some embodiments of the present application, an operation of preprocessing the real-time environment data of each area may include, but is not limited to, data cleaning, which can remove noise, missing values, or outliers to ensure an accuracy of the real-time environment data.

In some embodiments of the present application, a method for training the artificial intelligence model may include: determining an artificial intelligence algorithm based on characteristics of the real-time environment data, such as a long short-term memory network, a support vector machine, or a deep learning model, for constructing the artificial intelligence model; using historical environment data, temperature change trends and temperature difference information that are associated with the historical environment data as a training set to train the artificial intelligence model, and enabling the artificial intelligence model to accurately predict the temperature change trend for a future period and to identify temperature difference information between different areas.

In some embodiments of the present application, the temperature control method may also include: collecting feedback information of a comparison between an actual temperature change trend and a temperature change trend predicted by the artificial intelligence model, and a comparison between actual temperature difference information and temperature difference information predicted by the artificial intelligence model, to evaluate a prediction accuracy of the artificial intelligence model; continuously optimizing and adjusting the artificial intelligence model based on the feedback information to improve the prediction accuracy and a robustness; regularly updating the artificial intelligence model to adapt to a new application scenario and new data characteristics.

In the above embodiment, the artificial intelligence model can identify the characteristics of patterns and trends in the data through complex mathematical models and machine learning techniques to predict the temperature change trend and potential temperature difference information in the future, such as local overheating areas or overcooling areas, abnormal temperature fluctuations, etc., which helps to formulate and adjust strategies more scientifically in the future. In addition, the artificial intelligence model can automatically and quickly process a large amount of real-time environmental data, greatly improving the efficiency and accuracy of data processing. At the same time, the artificial intelligence model can also continue to learn and optimize, and continuously improve its own analysis ability and prediction accuracy.

In block S12, a preset strategy prediction model is utilized to dynamically adjust operating parameters of the temperature control devices based on the temperature change trend, the temperature difference information, and the target temperatures.

In some embodiments of the present application, the electronic device utilizes the preset strategy prediction model to dynamically adjust operating parameters of the temperature control devices based on the temperature change trend, the temperature difference information, and the target temperatures by: generating a control strategy by utilizing the preset strategy prediction model based on the temperature change trend, the temperature difference information, and the target temperatures; and dynamically adjusting the operating parameters of the temperature control devices according to the control strategy.

In some embodiments of the present application, the operating parameters may include, but are not limited to, a cooling power, a heating power, a fan speed, a fan direction, and an air volume.

In some embodiments of the present application, the control strategy may include, but is not limited to, adjusting the target temperature of the temperature control device, changing an operating mode (e.g., heating, cooling, standby), adjusting a fan speed, adjusting a fan direction, and adjusting an air volume of the temperature control device.

In some embodiments of the present application, a method for training the strategy prediction model may include: determining a machine learning model, such as a decision tree, a random forest, or a neural network based on the temperature change trend, the temperature difference information, and the target temperatures, for constructing the strategy prediction model; using prestored control strategies and historical temperature change trends, historical temperature difference information, and historical target temperatures that are corresponding to the prestored control strategies as a training set to train the strategy prediction model, enabling the strategy prediction model to accurately generate control strategies.

In the above embodiments, the strategy prediction model can precisely predict control strategies based on the temperature change trends, temperature difference information, and target temperatures, dynamically adjusting the operating parameters of the temperature control device to ensure that an indoor temperature remains within a target range that is preset, avoiding excessive temperature fluctuations. This improves the accuracy and stability of temperature control, reduces unnecessary energy consumption, and achieves a goal of energy conservation and emission reduction. Due to the improved accuracy and stability of temperature control, the user can enjoy a more comfortable environment. Whether in homes, offices, or public places, a balanced and comfortable temperature can be maintained, meeting people's comfort needs and providing users with a more convenient and efficient experience.

In some embodiments of the present application, the temperature control method may also include the following block:

In block S13, a query instruction for a control issue of the temperature control device is obtained.

In some embodiments of the present application, the temperature control device can be any one of the temperature control devices installed in the multiple areas within the building. In some embodiments of the present application, a dialogue robot 3 can be provided for users (e.g., floor managers, maintenance personnel, residents, etc.) to obtain the query instruction for a control issue of the temperature control device. The query instruction may include, but is not limited to, voice information. The dialogue robot 3 communicates with the electronic device 10.

In other embodiments, the user may also submit the query instruction for the control issue of the temperature control device through a website, a mobile phone, and a computer. The present application does not limit a method of interacting with the user.

In block S14, a control recommendation for the control issue is provided to the user based on the query instruction and the control strategy.

Specifically, the providing of the control recommendation for the control issue to the user based on the query instruction and the control strategy includes: identifying key information from the query instruction; retrieving historical information related to the key information from a preset control database; providing the control recommendation for the control issue to the user based on the historical information and the control strategy, and displaying the control recommendation on a display device 4.

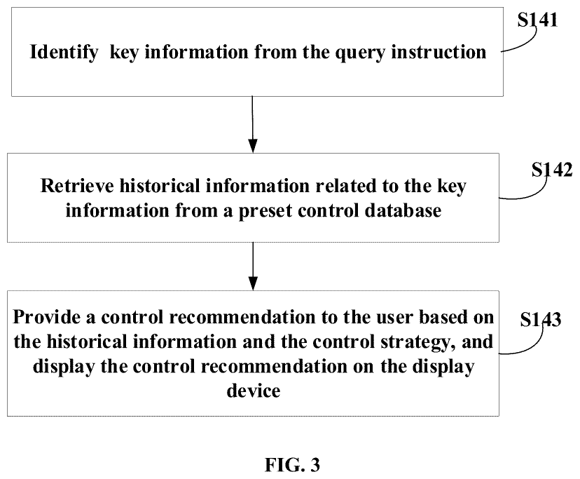

It should be noted that a detailed description of how to provide the control recommendation based on the query instruction and the control strategy is illustrated in subsequent blocks shown in FIG. 3. To avoid redundancy, further details are not repeated here.

The temperature control method of the present application achieves a real-time monitoring, an intelligent analysis, and a dynamic adjustment of the temperatures within the building, improving a balance of temperatures across different areas within the building, enhancing an efficiency of temperature management and the comfort of the user, and reducing an energy consumption while improving an energy utilization.

FIG. 3 illustrates a block diagram of a temperature control method according to an embodiment of the present application.

This embodiment provides a detailed explanation of the block S14, further describing how to provide the control recommendation based on the query instruction and the control strategy. Block S14 includes following blocks:

Block S141: Key information is identified from the query instruction.

In some embodiments of the present application, the key information is accurately extracted from the query instruction using a natural language processing technology or a preset keyword matching algorithm.

In some embodiments, the key information may include, but is not limited to, an operating mode, an operating duration, and a control requirement.

Block S142: historical information related to the key information is retrieved from a preset control database.

In some embodiments of the present application, the control database stores control information and habits of users regarding different temperature control devices under various environmental conditions. A preset retrieval algorithm (e.g., an index query, a full-text search is used to quickly locate the historical information related to the current query instruction.

Block S143: A control recommendation is provided to the user based on the historical information and the control strategy, and is displayed on the display device.

In some embodiments of the present application, the retrieved historical information and the control strategy are combined to conduct reasoning and calculations to generate personalized control recommendation for the user.

In some embodiments, the display device 4 may include, but is not limited to, a screen, a projector, a mobile device (e.g., a phone, a laptop, a handheld computer), etc.

In the above embodiments, the automatic and intelligent method can quickly respond to the user's query instruction and generate the personalized control recommendation, which can be more intuitive and convenient, help to improve the user's satisfaction and experience, and can more accurately control the operation of the temperature control device to avoid unnecessary energy waste, so as to achieve the goal of energy conservation and emission reduction. The generated control recommendation is displayed to the user on the display device 4, which is more intuitive and convenient, and helps to improve the user's satisfaction and experience.

In some embodiments of the present application, the temperature control method may also include following blocks: obtaining energy consumption data of each temperature control device; adjusting the control strategy based on the energy consumption data, the temperature change trend, and the temperature difference information.

Specifically, the temperature control device may have energy consumption monitoring functions, capable of real-time recording and displaying energy consumption data. In the above embodiments, by adjusting the control strategy, energy consumption of the temperature control device can be effectively reduced, improving energy efficiency. The optimized control strategy can better adapt to temperature changes, maintaining the stability and comfort of indoor temperatures. It also reduces unnecessary energy consumption and equipment wear, lowering operating and maintenance costs.

In some embodiments of the present application, the temperature control method may also include the following blocks: obtaining feedback information regarding the control strategy; adjusting the control strategy based on the feedback information.

Specifically, the temperature control device may have a function of monitoring energy consumption that can record and display energy consumption data in real time.

In the above embodiments, by adjusting the control strategy, the energy consumption of the temperature control device can be effectively reduced and an energy efficiency level can be improved. The optimized control strategy can better adapt to a temperature change and maintain the stability and comfort of indoor temperature. It can also reduce unnecessary energy consumption and device loss, and reduce operation and maintenance costs.

In some embodiments of this application, the temperature control method may also include the following blocks: obtaining a feedback information on the control strategy; adjusting the control strategy based on the feedback information.

In the above embodiments, deficiencies in the actual application of the control strategy can be found in time by obtaining the feedback information, so as to make targeted adjustments. This dynamic adjustment process makes the control strategy more adaptable to the changes of the actual environment and conditions, and enhances its adaptability and flexibility. By analyzing the feedback information, inadequacies in resource allocation and use can be found, so as to optimize and adjust the resources, reduce the waste of resources, improve the efficiency of resource utilization, and reduce the operation and maintenance costs. By obtaining the feedback information of users, it can understand the actual feelings and satisfaction of users on the control strategy, so as to improve and optimize the overall experience and satisfaction of users.

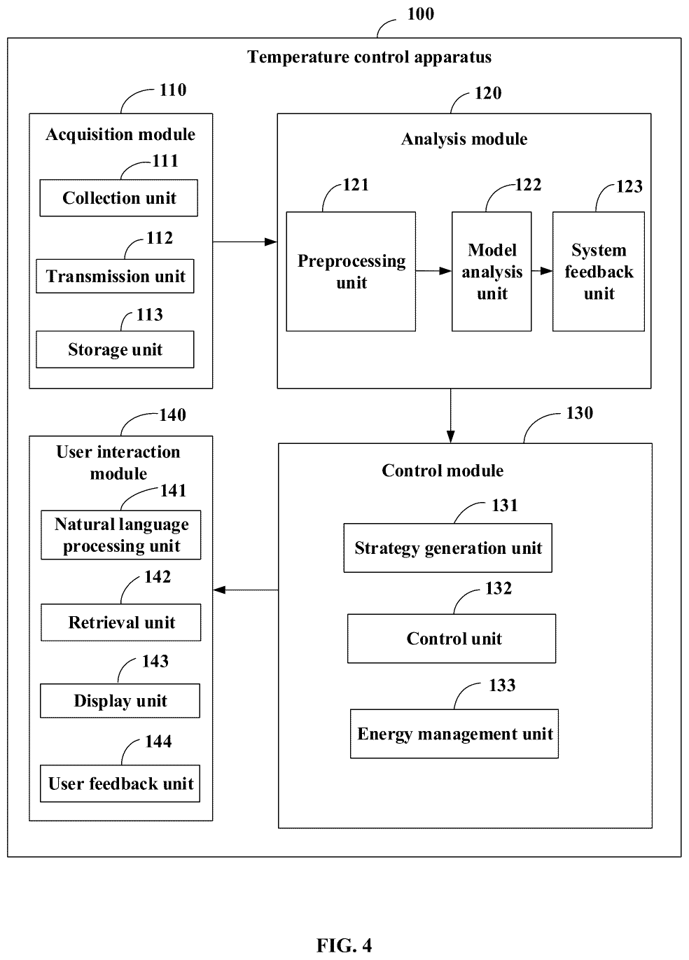

A schematic structure of a temperature control apparatus 100 is provided by one embodiment of this application, as shown in FIG. 4.

In the embodiment, based on a same idea as the temperature control method in the above embodiment, the application also provides the temperature control apparatus 100 that can be used to perform the temperature control method. For a sake of illustration, the schematic diagram of the temperature control apparatus 100 shows only those parts relevant to the embodiments of the present application, and it is understood by those skilled in the art that the schematic structure does not constitute a limitation of the temperature control apparatus 100 and may include more or fewer parts than the schematic diagram, or a combination of some parts, or a different arrangement of parts.

Specifically, the temperature control apparatus 100 provided in this embodiment of the present application includes an acquisition module 110, an analysis module 120, and a control module 130.

The acquisition module 110 is used to obtain real-time environment data of multiple areas within a building and to obtain target temperatures of temperature control devices in the multiple areas.

In some embodiments of the present application, the real-time environment data includes temperature data and personnel activity data.

Specifically, the acquisition module 110 includes a collection unit 111, a transmission unit 112, and a storage unit 113.

Temperature sensors 1 are installed in the multiple areas (e.g., a first area, and a second area) within the building, and are communicated with the electronic device 10. The collection unit 111 obtains the temperature data collected by the temperature sensors 1 and monitors temperatures of the multiple areas within the building in real time according to the collected temperature data.

Image sensors 2 (e.g., cameras) are installed in the multiple areas (e.g., the first area, and the second area) within the building, and are communicated with the electronic device 10. The image sensors 2 capture image data in the multiple areas within the building in real time. The collection unit 111 obtains the image data from the image sensors 2; performs preprocessing operations, such as an image denoising, a background removal, and an image enhancement on the image data; and obtains the personnel activity data by extracting features of personnel activities based on a deep learning model (e.g., a convolutional neural network, a recurrent neural network).

The electronic device 10 integrates a management system for the temperature control devices, such as a centralized air conditioning control system, such that the collection unit 111 can obtain the target temperatures set by users for the temperature control devices installed in the multiple areas from the management system that is integrated.

In the above embodiments, by installing the temperature sensors 1 and the image sensors 2 in different areas within the building, the temperature data and the personnel activity data can be monitored in real time. This provides a more comprehensive actual environmental status for a subsequent adjustment of operating parameters of the temperature control devices, allowing for a precise regulation based on actual environmental conditions. For example, a ventilation can be increased in a densely populated area, and the target temperatures can be lowered in an area with a higher temperature to maintain a comfortable indoor environment.

In other embodiments, the real-time environment data may also include, but is not limited to, humidity data, energy consumption data, and sound data.

In some embodiments of the present application, the building may be a residential building, an office building, and a shopping mall. The present application does not limit on this. The multiple areas within the building may include, but are not limited to, areas located at different positions within the building.

In some embodiments of the present application, the temperature control devices are installed in different areas within the building, which may include, but are not limited to, compressors and air supply fans.

The transmission unit 112 is used to transmit the real-time environment data to the analysis module 120 or a central database via a wireless communication method (e.g., Bluetooth, WiFi) or a wired communication method (e.g., fiber optics, Ethernet).

The storage unit 113 is used to store the real-time environment data in a preset local database or a preset cloud server. In the above embodiments, storing the real-time environment data in the local database can improve the speed of accessing the real-time environment data, enabling instant responses when analyzing the real-time environment data. It also reduces the risk of the real-time environment data being intercepted or leaked during transmission, helping to protect the security and privacy of the real-time environment data within the building. In an event of an instability or an interruption if occurred in a network, the local database can still function normally, ensuring a continuity and an integrity of the real-time environment data. The cloud server typically has automatic backup and recovery functions, which can effectively prevent a loss and a damage of the real-time environment data, ensuring an integrity and an availability of the real-time environment data. The cloud server allows a building manager and maintenance personnel to access the real-time environment data from different locations via the internet, enabling a remote monitoring and management, supporting a multi-person collaboration, and improving a work efficiency and a convenience of sharing the real-time environment data.

The analysis module 120 is used to utilize a preset artificial intelligence model to predict the temperature change trend of each area and to identify temperature difference information between different areas based on the real-time environment data.

Specifically, the analysis module 120 includes a preprocessing unit 121, a model analysis unit 122, and a system feedback unit 123.

In some embodiments of the present application, it is necessary to pre-associate the location marker of each area with the real-time environment data of each area. This allows for predicting the temperature change trend of each area and identifying temperature difference information between different areas based on the real-time environment data of each area.

Specifically, the preprocessing unit 121 is used to perform a preprocessing operation on the real-time environment data of each area to obtain preprocessed real-time environment data. The model analysis unit 122 is used to utilize the artificial intelligence model, to predict the temperature change trend of each area and to identify temperature difference information between different areas, based on the preprocessed real-time environment data.

In some embodiments of the present application, the preprocessing operation may include, but are not limited to, data cleaning, which can remove noise, missing values, or outliers to ensure the accuracy of the real-time environment data.

In some embodiments of the present application, a method for training the artificial intelligence model may include: determining an artificial intelligence algorithm based on characteristics of the real-time environment data, such as a long short-term memory network, a support vector machine, or a deep learning model, for constructing the artificial intelligence model; using historical environment data, temperature change trends and temperature difference information that are associated with the historical environment data as a training set to train the artificial intelligence model, and enabling the artificial intelligence model to accurately predict the temperature change trend for a future period and to identify temperature difference information between different areas.

The system feedback unit 123 is used to collect feedback information of a comparison between an actual temperature change trend and a temperature change trend predicted by the artificial intelligence model, and a comparison between actual temperature difference information and temperature difference information predicted by the artificial intelligence model, to evaluate a prediction accuracy of the artificial intelligence model; continuously optimize and adjust the artificial intelligence model based on the feedback information to improve the prediction accuracy and a robustness; regularly update the artificial intelligence model to adapt to a new application scenario and new data characteristics.

In the above embodiment, the artificial intelligence model can identify the characteristics of patterns and trends in the data through complex mathematical models and machine learning techniques to predict the temperature change trend and potential temperature difference information in the future, such as local overheating areas or overcooling areas, abnormal temperature fluctuations, etc., which helps to formulate and adjust strategies more scientifically in the future. In addition, the artificial intelligence model can automatically and quickly process a large amount of real-time environmental data, greatly improving the efficiency and accuracy of data processing. At the same time, the artificial intelligence model can also continue to learn and optimize, and continuously improve its own analysis ability and prediction accuracy.

The control module 130 is used to utilize a preset strategy prediction model to dynamically adjust the operating parameters of the temperature control devices based on the temperature change trend, temperature difference information, and target temperatures.

Specifically, the control module 130 includes a strategy generation unit 131 and a control unit 132.

In some embodiments of the present application, the strategy generation unit 131 is used to utilize the preset strategy prediction model, based on the temperature change trend, temperature difference information, and target temperatures, to generate the control strategy. The control unit 132 is used to dynamically adjust the operating parameters of the temperature control devices according to the control strategy.

In some embodiments of the present application, the operating parameters may include, but are not limited to, a cooling power, a heating power, a fan speed, a fan direction, and an air volume. In some embodiments of the present application, the control strategy may include, but are not limited to, adjusting the target temperature of the temperature control device, changing an operating mode (e.g., heating, cooling, standby), adjusting a fan speed, adjusting a fan direction, and adjusting an air volume of the temperature control device.

In some embodiments of the present application, a method for training the strategy prediction model may include: determining a machine learning model, such as a decision tree, a random forest, or a neural network based on the temperature change trend, the temperature difference information, and the target temperatures, for constructing the strategy prediction model; using prestored control strategies and historical temperature change trends, historical temperature difference information, and historical target temperatures that are corresponding to the prestored control strategies as a training set to train the strategy prediction model, enabling the strategy prediction model to accurately generate control strategies.

In the above embodiments, the strategy prediction model can precisely predict control strategies based on the temperature change trends, temperature difference information, and target temperatures, dynamically adjusting the operating parameters of the temperature control device to ensure that an indoor temperature remains within a target range that is preset, avoiding excessive temperature fluctuations. This improves the accuracy and stability of temperature control, reduces unnecessary energy consumption, and achieves a goal of energy conservation and emission reduction. Due to the improved accuracy and stability of temperature control, the user can enjoy a more comfortable environment. Whether in homes, offices, or public places, a balanced and comfortable temperature can be maintained, meeting people's comfort needs and providing users with a more convenient and efficient experience.

In some embodiments of the present application, the control module 130 may further include an energy management unit 133. The energy management unit 133 is used to obtain energy consumption data of each temperature control device and adjust the control strategy based on the energy consumption data, the temperature change trend, and the temperature difference information. Specifically, the temperature control device may have energy consumption monitoring functions, capable of real-time recording and displaying energy consumption data. In the above embodiments, by adjusting the control strategy, energy consumption of the temperature control device can be effectively reduced, improving energy efficiency. The optimized control strategy can better adapt to temperature changes, maintaining the stability and comfort of indoor temperatures. It also reduces unnecessary energy consumption and equipment wear, lowering operating and maintenance costs.

In some embodiments of the present application, the temperature control apparatus 100 may further include a user interaction module 140, which is used to obtain a query instruction for a control issue of the temperature control device and provide a control recommendation for the control issue to the user based on the query instruction and the control strategy.

In some embodiments, a dialogue robot 3 can be provided for users (e.g., floor managers, maintenance personnel, residents, etc.) to obtain the query instruction for a control issue of the temperature control device. The query instruction may include, but is not limited to, voice information. The dialogue robot 3 communicates with electronic device 10.

In other embodiments, the user may also submit the query instruction for the control issue of the temperature control device through a website, a mobile phone, and a computer. The present application does not limit a method of interacting with the user.

Specifically, the user interaction module 140 includes a natural language processing unit 141, a retrieval unit 142, and a display unit 143.

The natural language processing unit 141 is used to identify key information from the query instruction; the retrieval unit 142 is used to retrieve historical information related to the key information from a preset control database; the display unit 143 is used to provide the control recommendation for temperature control apparatus adjustments to the user based on the retrieved historical information and the predicted control strategy, and display the control recommendation on display device 4.

In some embodiments of the present application, the key information is accurately extracted from the query instruction using the natural language processing technology or the preset keyword matching algorithm.

In some embodiments, the key information may include, but is not limited to, an operating mode, an operating duration, and a control requirement.

In some embodiments of the present application, the control database stores control information and habits of users regarding different temperature control devices under various environmental conditions. A preset retrieval algorithm (e.g., an index query, a full-text search is used to quickly locate the historical information related to the current query instruction.

In some embodiments of the present application, the retrieved historical information and the control strategy are combined to conduct reasoning and calculations to generate personalized control recommendation for the user.

In some embodiments, the display device 4 may include, but is not limited to, a screen, a projector, a mobile device (e.g., a phone, a laptop, a handheld computer), etc.

In the above embodiments, the automatic and intelligent method can quickly respond to the user's query instruction and generate the personalized control recommendation, which can be more intuitive and convenient, help to improve the user's satisfaction and experience, and can more accurately control the operation of the temperature control device to avoid unnecessary energy waste, so as to achieve the goal of energy conservation and emission reduction. The generated control recommendation is displayed to the user on the display device 4, which is more intuitive and convenient, and helps to improve the user's satisfaction and experience.

In some embodiments of the present application, the user interaction module 140 may further include a user feedback unit 144. The user feedback unit 144 is used to obtain feedback information regarding the control strategy and adjust the control strategy based on the feedback information. In the above embodiments, by obtaining feedback information, any shortcomings of the control strategy in practical applications can be promptly identified, allowing for targeted adjustments.

In the above embodiments, by obtaining feedback information, the deficiencies of the control strategy in actual application can be discovered in time, so as to make targeted adjustments. This dynamic adjustment process makes the control strategy more adaptable to changes in the actual environment and conditions, and enhances its adaptability and flexibility. By analyzing the feedback information, the deficiencies in resource allocation and use can be discovered, so as to make optimization adjustments, which helps to reduce the waste of resources, improve resource utilization efficiency, and reduce operation and maintenance costs. By obtaining user's feedback information, the user's actual feelings and satisfaction with the control strategy can be understood, so as to make improvements and optimizations, and improve the user's overall experience and satisfaction.

The temperature control apparatus 100 of the embodiment of the present application realizes a real-time monitoring, an intelligent analysis and a dynamic control of the internal temperatures of the building, improves the temperature balance between different areas in the building, improves the temperature management efficiency inside the building and the living comfort of users, and also reduces energy consumption and improves energy utilization.

FIG. 2 is a schematic diagram of a hardware structure of an electronic device 10 provided in an embodiment of the present application.

In some embodiments of the present application, the electronic device 10 includes, but is not limited to, a storage device 11, a processor 12, and a computer program 13 such as a temperature control program stored in the storage device 11 and executable by the processor 12.

Those skilled in the art may understand that the schematic diagram is merely an example of the electronic device 10 and does not constitute a limitation on the electronic device 10. The electronic device 10 may include more or fewer components than shown in the diagram, or a combination of certain components, or different components. For example, the electronic device 10 may also include input and output devices, network access devices, buses, etc.

The processor 12 obtains an operating system and various installed applications of the electronic device 10. The processor 12 obtains the application to implement the blocks in the above-mentioned various embodiments of the temperature control method, such as the blocks shown in FIG. 1 and FIG. 3.

Exemplarily, the computer program 13 may be divided into one or more modules/units, one or more modules/units are stored in the storage device 11, and are acquired by the processor 12 to complete the present application. One or more modules/units may be a series of segments of computer program instructions capable of completing specific functions, and the segments of instructions are used to describe an acquisition process of the computer program 13 in the electronic device 10.

In some embodiments of the present application, the electronic device 10 includes a device that can automatically perform numerical calculations and/or information processing according to pre-set or stored instructions. The hardware of the electronic device 10 includes, but is not limited to, a microprocessor, an application specific integrated circuit (ASIC), a field programmable gate array (FPGA), a digital signal processor (DSP), an embedded device, etc.

In some embodiments of the present application, the network where the electronic device 10 is located includes, but is not limited to: the Internet, a wide area network, a metropolitan area network, a local area network, a virtual private network (VPN), etc.

In some embodiments of the present application, the storage device 11 is used to store program codes and various data, such as the temperature control apparatus 100 installed in the electronic device 10, and to achieve a high-speed and an automatic access to programs or data during the operation of the electronic device 10. The storage device 11 may include a read-only memory (ROM), a random access memory (RAM), a programmable read-only memory (PROM), an erasable programmable read-only memory (EPROM), a one-time programmable read-only memory (OTPROM), an electronically erasable rewritable read-only memory (EEPROM), a compact disc read-only memory (CD-ROM) or other optical disc storage, magnetic disk storage, magnetic tape storage, or any other computer-readable medium that can be used to carry or store data.

In some embodiments of the present application, the storage device 11 may also be an external storage device and/or an internal storage device of the electronic device 10. Furthermore, the storage device 11 may be a storage device in a physical form, such as a memory stick, a trans-flash (TF) card, and the like.

In some embodiments of the present application, the processor 12 may be a central processing unit (CPU), or other general-purpose processors, a digital signal processors (DSP), an application-specific integrated circuits (ASIC), a field-programmable gate arrays (FPGA) or other programmable logic devices, discrete gate or transistor logic devices, discrete hardware components, etc. The general-purpose processor may be a microprocessor or any conventional processor, etc. The processor 12 is a computing core and a control center of the electronic device 10, and uses various interfaces and lines to connect various parts of the entire electronic device 10, and invokes the data stored in the storage device 11 to execute various functions of the electronic device 10 and process data, such as executing the temperature control function.

In some embodiments of the present application, the processor 12 is used to obtain the operating system and various installed applications of the electronic device 10. For example, the processor 12 obtains the temperature control program to implement the temperature control method of the above embodiment, such as the blocks shown in FIG. 1 and FIG. 3.

In one embodiment of the present application, the electronic device 10 may further include a power supply (not shown) for supplying power to each component. Preferably, the power supply may be logically connected to the processor 12 through a power management device, so that the power management device can manage charging, discharging, and power consumption. The power supply may also include one or more DC or AC power supplies, recharging devices, power failure detection circuits, power converters or inverters, power status indicators, and other arbitrary components. The electronic device 10 may also include a variety of sensors, Bluetooth modules, Wi-Fi modules, etc., which will not be described in detail here.

In one embodiment of the present application, if the module/submodule integrated in the electronic device 10 is implemented in the form of a software functional submodule and sold or used as an independent workpiece, it can be stored in a computer-readable storage medium. Based on this understanding, the present application implements all or part of the process in the above-mentioned embodiment method, and can also be completed by instructing the relevant hardware through a computer program 13. The computer program 13 can be stored in a computer-readable storage medium. When the computer program 13 is obtained by the processor 12, the blocks of each method embodiment shown in FIG. 1 can be implemented.

In one embodiment of the present application, the computer program 13 may include computer program code, which may be in source code form, object code form, an accessible file, or some intermediate form, etc. The computer readable medium may include: any entity or device, recording mediums, USB flash drives, mobile hard disks, magnetic disks, optical disks, computer memory, and read-only memory (ROM) that are capable of carrying computer program code.

The storage device 11 in the electronic device 10 stores a plurality of instructions to implement the temperature control method, and the processor 12 can obtain the plurality of instructions to implement the temperature control method of the above embodiment.

Specifically, the specific implementation method of the processor 12 for the above instructions can refer to the description of the relevant blocks in the corresponding embodiments of FIG. 1 and FIG. 3, which will not be repeated here.

In the several embodiments provided in this application, it should be understood that the disclosed methods and devices can be implemented in other ways. For example, the device embodiments described above are only schematic, for example, the division of modules is only a logical function division, and there may be other division methods in actual implementation.

The modules described as separate components may or may not be physically separated, and the components shown as modules may or may not be physical units, that is, they may be located in one place or distributed on multiple network units. Some or all of the modules may be selected according to actual needs to achieve the purpose of the solution of this embodiment.

Each functional module in each embodiment of the present application can be integrated into a processing submodule, or each submodule can exist physically separately, or two or more submodules can be integrated into one submodule. The above-mentioned integrated submodule can be implemented in the form of hardware or in the form of hardware plus software functional modules.

Therefore, no matter from which point of view, the embodiments should be regarded as illustrative and non-restrictive, and the scope of the present application is limited by the appended claims rather than the above description, so it is intended that all changes falling within the meaning and scope of the equivalent elements of the claims are included in the present application. Any attached figure mark in the claims should not be regarded as limiting the claims involved.

In addition, it is obvious that the word “comprising” does not exclude other submodules or blocks, and the singular does not exclude the plural. The multiple submodules or devices stated in this application can also be implemented by one submodule or device through software or hardware.

Finally, it should be noted that the above embodiments are only used to illustrate the technical solution of the present application and are not intended to limit it. Although the present application has been described in detail with reference to the preferred embodiments, a person of ordinary skill in the art should understand that the technical solution of the present application may be modified or replaced by equivalents without departing from the spirit and scope of the technical solution of the present application.

What is claimed is:

1. A temperature control method, comprising:
obtaining real-time environmental data of a plurality of areas in a building, and obtaining target temperatures of temperature control devices in the plurality of areas, the real-time environmental data comprising temperature data and personnel activity data;
predicting a temperature change trend of each of the plurality of areas and identifying temperature difference information between the plurality of areas by using a preset artificial intelligence model based on the real-time environmental data; and
adjusting operating parameters of the temperature control devices by using a preset strategy prediction model based on the temperature change trend, the temperature difference information and the target temperatures.

2. The temperature control method according to claim 1, wherein adjusting operating parameters of the temperature control devices by using the preset strategy prediction model based on the temperature change trend, the temperature difference information and the target temperatures comprises:
generating a control strategy based on the temperature change trend, the temperature difference information and the target temperatures by using the preset strategy prediction model; and
adjusting the operating parameters of the temperature control devices according to the control strategy.

3. The temperature control method according to claim 2, further comprising:
obtaining energy consumption data of each of the temperature control devices; and
adjusting the control strategy based on the energy consumption data, the temperature change trend, and the temperature difference information.

4. The temperature control method according to claim 2, further comprising:
obtaining a query instruction for a control issue of one of the temperature control devices; and
providing a control recommendation for the control issue based on the query instruction and the control strategy.

5. The temperature control method according to claim 4, wherein providing the control recommendation for the control issue based on the query instruction and the control strategy comprises:
identifying key information from the query instruction;
retrieving historical information related to the key information from a preset control database based on the key information;
providing the control recommendation for the control issue based on the historical information and the control strategy, and
displaying the control recommendation on a display device.

6. The temperature control method according to claim 2, further comprising:
obtaining feedback information for the control strategy; and
adjusting the control strategy based on the feedback information.

7. The temperature control method according to claim 1, wherein predicting the temperature change trend of each of the plurality of areas and identifying temperature difference information between the plurality of areas by using the preset artificial intelligence model based on the real-time environmental data comprises:
preprocessing the real-time environment data of each of the multiply areas to obtain preprocessed real-time environment data of each of the multiply areas; and
predicting the temperature change trend of each area and identifying the temperature difference information between the plurality of areas by utilizing the artificial intelligence model based on the preprocessed real-time environment data.

8. An electronic device, comprising
at least one processor; and
a storage device, being stored with a computer program, which when executed by the at least one processor, caused the at least one processor to:
obtain real-time environmental data of a plurality of areas in a building, and obtain target temperatures of temperature control devices in the plurality of areas, the real-time environmental data comprising temperature data and personnel activity data;
predict a temperature change trend of each of the plurality of areas and identifying temperature difference information between the plurality of areas by using a preset artificial intelligence model based on the real-time environmental data; and
adjust operating parameters of the temperature control devices by using a preset strategy prediction model based on the temperature change trend, the temperature difference information and the target temperatures.

9. The electronic device according to claim 8, wherein the at least one adjusts operating parameters of the temperature control devices by using the preset strategy prediction model based on the temperature change trend, the temperature difference information and the target temperatures by:
generating a control strategy based on the temperature change trend, the temperature difference information and the target temperatures by using the preset strategy prediction model; and
adjusting the operating parameters of the temperature control devices according to the control strategy.

10. The electronic device according to claim 9, wherein the at least one processor is further caused to:
obtain energy consumption data of each of the temperature control devices; and
adjust the control strategy based on the energy consumption data, the temperature change trend, and the temperature difference information.

11. The electronic device according to claim 9, wherein the at least one processor is further caused to:
obtain a query instruction for a control issue of one of the temperature control devices; and
provide a control recommendation for the control issue based on the query instruction and the control strategy.

12. The electronic device according to claim 11, wherein the at least one processor provides the control recommendation for the control issue based on the query instruction and the control strategy by:
identifying key information from the query instruction;
retrieving historical information related to the key information from a preset control database based on the key information;
providing the control recommendation for the control issue based on the historical information and the control strategy, and
displaying the control recommendation on a display device.

13. The electronic device according to claim 9, wherein the at least one processor is further caused to:
obtain feedback information for the control strategy; and
adjust the control strategy based on the feedback information.

14. The electronic device according to claim 8, wherein the at least one processor predicts the temperature change trend of each of the plurality of areas and identifying temperature difference information between the plurality of areas by using the preset artificial intelligence model based on the real-time environmental data by:
preprocessing the real-time environment data of each of the multiply areas to obtain preprocessed real-time environment data of each of the multiply areas; and
predicting the temperature change trend of each area and identifying the temperature difference information between the plurality of areas by utilizing the artificial intelligence model based on the preprocessed real-time environment data.

15. A non-transitory storage medium, being stored with a computer program, which when executed by a processor, a temperature control method is implemented, wherein the temperature control method comprises:
obtaining real-time environmental data of a plurality of areas in a building, and obtaining target temperatures of temperature control devices in the plurality of areas, the real-time environmental data comprising temperature data and personnel activity data;
predicting a temperature change trend of each of the plurality of areas and identifying temperature difference information between the plurality of areas by using a preset artificial intelligence model based on the real-time environmental data; and
adjusting operating parameters of the temperature control devices by using a preset strategy prediction model based on the temperature change trend, the temperature difference information and the target temperatures.

16. The non-transitory storage medium according to claim 15, wherein adjusting operating parameters of the temperature control devices by using the preset strategy prediction model based on the temperature change trend, the temperature difference information and the target temperatures comprises:
generating a control strategy based on the temperature change trend, the temperature difference information and the target temperatures by using the preset strategy prediction model; and
adjusting the operating parameters of the temperature control devices according to the control strategy.

17. The non-transitory storage medium according to claim 16, wherein the temperature control method further comprises:
obtaining energy consumption data of each of the temperature control devices; and
adjusting the control strategy based on the energy consumption data, the temperature change trend, and the temperature difference information.

18. The non-transitory storage medium according to claim 16, wherein the temperature control method further comprises:
obtaining a query instruction for a control issue of one of the temperature control devices; and
providing a control recommendation for the control issue based on the query instruction and the control strategy.

19. The non-transitory storage medium according to claim 18, wherein providing the control recommendation for the control issue based on the query instruction and the control strategy comprises:
identifying key information from the query instruction;
retrieving historical information related to the key information from a preset control database based on the key information;
providing the control recommendation for the control issue based on the historical information and the control strategy, and
displaying the control recommendation on a display device.

20. The non-transitory storage medium according to claim 16, wherein the temperature control method further comprises:
obtaining feedback information for the control strategy; and
adjusting the control strategy based on the feedback information.
